(19) United States
(12) Patent Application Publication
(10) Pub. No.: US 2006/0161322 A1
(43) Pub. Date: Jul. 20, 2006

(54) Seat belt monitoring system

(76) Inventor: Nnaemeka Prince Njoku, Johnson City, TN (US)

Correspondence Address: Prince Njoku, P.O. Box 21699, Johnson City, TN, 37614, US

(21) Appl. No.: 11/036,976

(22) Filed: Jan. 18, 2005

(51) Int. Cl. G06F 17/00

(52) U.S. Cl. 701/45; 340/439; 701/1

(57) ABSTRACT

A seat belt monitoring system for registering and recording the physical conditions of occupants through an active restraint system commonly referred to as a seat belt, in commercial or private vehicles and other human-operated equipment. The restraint system is equipped with a data processor that allows body temperature and heart beat echo monitoring during normal operation of the vehicles. The system allows the occupant to view the complied information on a vehicle display located in the dash console.

### BRIEF DESCRIPTION OF THE DRAWING

In order that the manner in which the advantages and features of the invention are obtained, a more particular description of the invention will become more apparent in the following detailed description and the preferred embodiment and the certain modification thereof when taken together with the accompanying drawing:

FIG. 1. Is schematic block drawing showing the seat belt location of the temperature sensor and heart sensor and how the data is carried to the microcomputer to Global Positioning, storage and vehicle console display.

### DETAILED DESCRIPTION PREFERRED EMBODIMENT

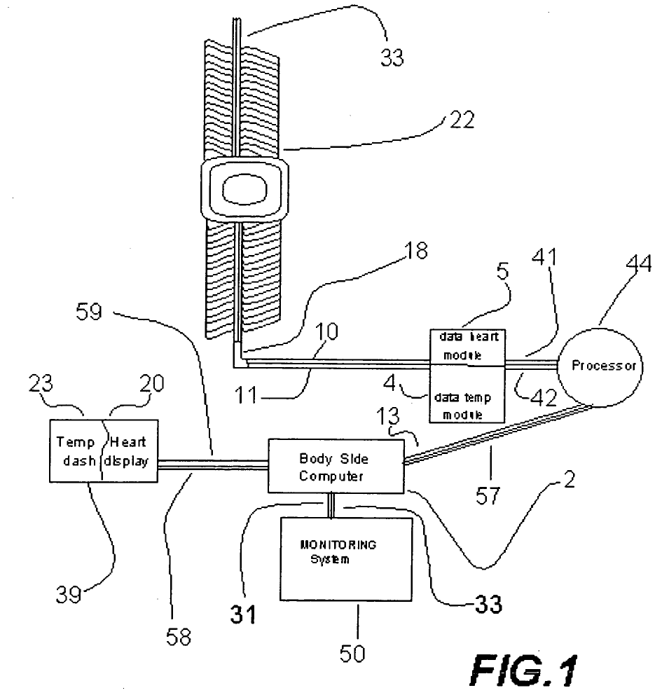

FIG. 1. 22 shows the seat belt design with sensors for the heart and temperature strips that collects data from the occupant physical condition and transmits the data to 18 the data block which line 10 transmits the heart data to 5 the heart data module and line 11 transmits the temperature data to 4 the temperature module. After entering their respective modules the heart data is transmitted from 41 line to 44 the processor and the temperature data is transmitted to the processor 44 by line 42.

After the informational processing by 44 the microprocessor transmits the analog-to-digital data to 2 the body side computer transmitted by line 58 the heart data and line 59 the temperature data to 39 the console display. 39 transmit the heart data to 20 that displays the digital heart read out and 23 the digital temperature read out.

In the invention the occupant physical read outs can be monitored by the occupants or an independent monitoring service through cell or a warning system.

Having now fully set forth the preferred embodiments and certain modifications of the concept underlying the present invention, various other embodiments as well as certain modifications herein shown and described will obviously occur to those skilled in the art upon becoming familiar with said underlying concept. It is to be understood, therefore, that the invention may be practiced otherwise than as specifically set forth herein.

1. A monitoring and data compiling system for active restraints in a vehicle comprising active usage indicating means for generating data when active restraints is engaged; body temperature and heart beat echo are compiled and displayed for the occupant.

2. The monitoring system of claim 1, further comprising data, wherein said processor means receives and incorporates occupants physical data into said unified console display.

3. The monitoring system of claim 1, further comprising global monitoring means receives and incorporates physical body data into said unified console display.

4. The monitoring system of claim 1, wherein said active restraints usage indicating means is comprised of an electric response of said active monitoring restraint.

5. The monitoring system of claim 1, wherein said processor means is comprised of an embedded microcomputer.

6. The monitoring system of claim 5, wherein said processor means further comprises analog-to-digital conversion means for receiving temperature and heart data.

7. A monitoring and data system for active restraints in a vehicle comprising active restraint usage indicating means for generating a body temperature signal when said active restraint is engaged; heart beat echo signal is monitored when active restraint system is engaged.

8. The monitoring system of claim 7, wherein said discrete events comprise: the active restraint; and the disengagement of said active restraint.

9. The monitoring system of claim 7, further comprising data, wherein said processor means receives and incorporates occupants physical body data into said unified console dash display.

10. The monitoring system of claim 7, further comprises global positioning means receives and incorporates occupants physical body data into said unified console display.

11. The monitoring system of claim 7, wherein said active restraint usage indicating means is comprised of a electric response of said active monitoring restraint.

12. The monitoring system of claim 7, wherein said processor means is comprised of an embedded microcomputer.

13. The monitoring system of claim 7, wherein said processor means further comprises analog-to-digital conversion means for receiving temperature and heart data.
